(19) United States
(12) Patent Application Publication
(10) Pub. No.: US 2015/0051965 A1
(43) Pub. Date: Feb. 19, 2015

(54) MEDIA CONTENT MANAGEMENT

(71) Applicant: KT Corporation, Seongnam-si (KR)

(72) Inventors: Sang-Pyo KONG, Seongnam-si (KR); Cheol-min LEE, Seongnam-si (KR)

(21) Appl. No.: 14/457,432

(22) Filed: Aug. 12, 2014

(30) Foreign Application Priority Data
Aug. 14, 2013 (KR) 10-2013-0096748

(51) Int. Cl. G06Q 20/12; G06Q 30/02; G06F 21/10

(52) U.S. Cl. CPC G06Q 20/1235; G06F 21/10; G06Q 30/0222; G06Q 30/0269
USPC 705/14.39; 726/28; 705/14.66

(57) ABSTRACT

In one example embodiment, a system includes a first device configured to transmit a request for temporary user rights to media content; and a server configured to: receive the request from the first device, transmit, to a second device having full user rights to the media content, a notification that the server will issue the temporary user rights to the media content to a user account authenticated on the first device, receive, from the second device, an approval to issue the temporary user rights to the media content to the user account authenticated on the first device, issue the temporary user rights to the user account authenticated on the first device, and temporarily revoke the full user rights to the media content from a user account authenticated on the second device.

### TECHNICAL FIELD

The embodiments described herein pertain generally to management of media content.

### BACKGROUND

A social networking service (SNS) is a platform to build social networks or social relationships among people who, for example, share interests, activities, backgrounds or real-life connections. Social networks include, typically, web-based services that allow individuals to create a public profile, to create a list of users with whom to connect for the purpose of sharing content, within the framework of the SNS system.

### SUMMARY

In one example embodiment, a system may include a first device configured to transmit a request for temporary user rights to media content. The system may also include a server configured to: receive the request from the first device; transmit, to a second device having full user rights to the media content, a notification that the server will issue the temporary user rights to the media content to a user account authenticated on the first device; receive, from the second device, an approval to issue the temporary user rights to the media content to the user account authenticated on the first device; issue the temporary user rights to the user account authenticated on the first device; and temporarily revoke the full user rights to the media content from a user account authenticated on the second device.

In another example embodiment, a server may include a transceiver configured to: receive, from a first device, a request for temporary user rights to media content; transmit, to a second device having full user rights to the media content, a notification that the server will issue the temporary user rights to the media content to a user account authenticated on the first device; and receive, from the second device, an approval to issue the temporary user rights to the media content to the user account authenticated on the first device. The server may also include a user rights manager configured to: issue the temporary user rights to the user account authenticated on the first device, and temporarily revoke the full user rights to the media content from a user account authenticated on the second device.

In yet another example embodiment, a method performed under control of a server may include: receiving, from a first device, a request for temporary user rights to media content; transmitting, to a second device having full user rights to the media content, a notification that the server will issue the temporary user rights to the media content to a user account authenticated on the first device; receiving, from the second device, an approval to issue the temporary user rights to the media content to the user account authenticated on the first device; issuing the temporary user rights to the user account authenticated on the first device; and temporarily revoking the full user rights to the media content from a user account authenticated on the second device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which media content management may be implemented, in accordance with various embodiments described herein;

FIGS. 2A to 2E show illustrative example devices by which at least portions of media content management may be implemented, in accordance with various embodiments described herein;

FIG. 3 shows an illustrative example of a notification transmitted by a server by which at least portions of media content management may be implemented, in accordance with various embodiments described herein;

FIGS. 4A to 4C show illustrative examples of an identifier storage of a server by which at least portions of media content management may be implemented, in accordance with various embodiments described herein;

FIG. 5 shows an example server by which at least portions of media content management may be implemented, in accordance with various embodiments described herein;

FIG. 6 shows an example processing flow of operations by which at least portions of media content management may be implemented, in accordance with various embodiments described herein; and

FIG. 7 shows an illustrative computing embodiment, in which any of the processes and sub-processes of media content management may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

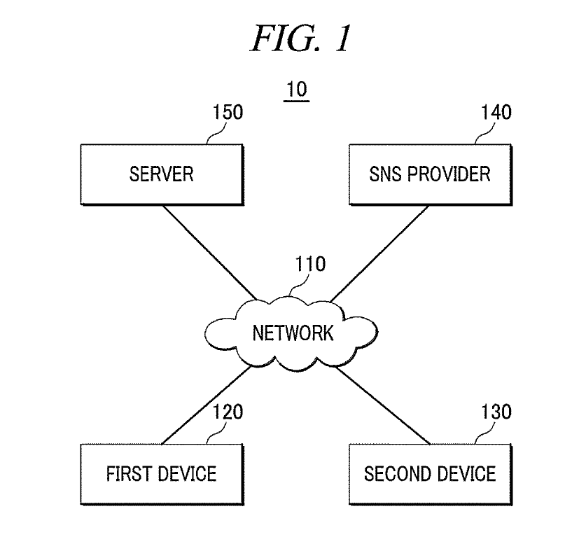

FIG. 1 shows an example system 10 in which media content management may be implemented, in accordance with various embodiments described herein. As depicted in FIG. 1, system configuration 10 may include, at least, a first device 120, a second device 130, a social network service (SNS) provider 140, and a server 150. At least two or more of first device 120, second device 130, SNS provider 140, and server 150 may be communicatively connected to each other via a network 110.

Network 110 may include, as non-limiting examples, wireless networks such as a mobile radio communication network including at least one of a 3rd generation (3G), 4^{th} generation (4G), or 5^{th} (5G) mobile telecommunications network, various other mobile telecommunications networks, a satellite network, WiBro (Wireless Broadband Internet), Mobile WiMAX, HSDPA (High Speed Downlink Packet Access), Bluetooth, or the like.

As non-limiting examples, a respective one of first device 120 and second device 130 may refer to a notebook computer, a personal computer, a smart phone, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

SNS provider 140 may refer to one or more apparatuses or servers hosted and/or supported by a service providing organization or entity that provides social networking services to multiple end devices, including first device 120 and second device 130. In some embodiments, SNS provider 140 may be configured to issue an SNS identifier to a user account authenticated on respective first device 120 and second device 130. Further, SNS provider 140 may be configured to associate the user account authenticated on first device 120 with the user account authenticated on second device 130, based on the SNS identifiers for each device 120 and 130, in the social network services. For example, SNS provider 140 may be configured to register the user account corresponding to first device 120 and the user account corresponding to second device 130 as social friends or social acquaintances.

Server 150 may refer to one or more processing apparatuses or servers hosted and/or supported by a service providing organization or entity that provides media content management services to multiple end devices, including first device 120 and second device 130. Server 150 may be one of multiple hosted servers or other processing apparatuses that may be configured to manage user rights to media content; issue and/or revoke user rights to media content; issue a unique identifier to each user account respectively authenticated on each device; store the issued unique identifier; and transmit media content to multiple end devices. For example, it may be assumed that server 150 may issue a formal authenticated identifier to the user account authenticated on second device 130, but server 150 has not yet issued a formal authenticated identifier to the user account authenticated on first device 120.

In some embodiments, first device 120 may be configured to transmit, from the user account authenticated on first device 120 to SNS provider 140, a request to transmit information associated with media content to which the user account authenticated on second device 130 has full user rights. For example, but not as a limitation, the media content may include at least one of eBooks, video files, audio files, e-coupons, e-gift cards, etc. Further, for example, full user rights to the media content may refer to authorization to access, use, play, reproduce, listen, read and/or download the media content. Full user rights to the media content have been purchased by the user or user's account authenticated on second device 130.

Further, for example, but not as a limitation, the information regarding the media content may include at least one of a title, an author, a number of authorized uses or plays for the media content or a period of time over which the media content may be used or played. In some embodiments, second device 130 may be configured to select media content which a user or user account authenticated on second device 130 wants to introduce and/or share to a user or user accounted authenticated on first device 120, from among media content to which the user or user account authenticated on second device 130 has full user rights. Further, second device 130 may be configured to transmit, from the corresponding authenticated user account to SNS provider 140, the information regarding the selected media content (e.g., titles and authors of the selected media content). Further, SNS provider 140 may be configured to transmit, to the user account authenticated on first device 120, a media content list that shows the titles and authors of the selected media content. Further, first device 120 may be configured to display the media content list on a display that may be part of, or communicatively coupled to, first device 120. Further, first device 120 may be configured to receive a user input to make at least one media content selection from the media content list.

Further, first device 120 may be configured to transmit, from the user account authenticated on first device 120 to server 150, a request for temporary user rights to the selected media content to which the user account authenticated on second device 130 has full user rights, based on the received user input. For example, but not as a limitation, the temporary user rights to the media content may refer to authorization to access, use, play, reproduce, listen, read and/or download the media content, restricted to a number of authorized uses or plays (e.g., playable twenty times) or an authorized period of time to use or play the media content (e.g., playable for a day).

First device 120 may be configured to transmit, from the user account authenticated on first device 120 to server 150, the request for the temporary user rights to the media content without an identifier for first device 120, since server 150 has not yet issued an authenticated identifier to the account corresponding to first device 120. Further, first device 120 may be configured to transmit, to server 150, the request for the temporary user rights to the media content, along with the identifier for second device 130. Server 150 may be configured to then issue, to the user account authenticated on first device 120, a temporary identifier for first device 120, based on the identifier for second device 130, upon receiving the request accompanied by the identifier for second device 130.

Server 150 may be configured to transmit, to second device 130, a notification that server 150 will issue, to the user account authenticated on first device 120, temporary user rights to the media content to which the user account authenticated on second device 130 has full user rights. For example, but not as a limitation, the notification may include information regarding a title of the media content selected by the user account authenticated on first device 120 and at least one of the SNS identifier or the temporary identifier for first device 120 that requested the temporary user rights. Further, server 150 may be configured to receive, from the user account authenticated on second device 130, approval to issue the temporary user rights to the media content to the user account authenticated on first device 120. Further, server 150 may be configured to issue, to the user account authenticated on first device 120, the temporary user rights to the media content, upon receiving the approval from the user account authenticated on second device 130.

Further, server 150 may be configured to receive, from first device 120, a request for the media content, based on the temporary user rights to the media content. Further, server 150 may be configured to transmit, to the user account authenticated on first device 120, the requested media content. The transmitted media content may be played or reproduced on first device 120, based on the temporary user rights to the media content for the number of authorized uses or plays or for the authorized period of time to use or play the media content, based on the temporary user rights to the media content. For example, server 150 may be configured to transmit, to first device 120, an electronic file to play the media content. For another example, server 150 may be configured to stream the media content to first device 120.

Further, server 150 may be configured to temporarily revoke the full user rights to the media content from the user account authenticated on second device 130, if the temporary user rights to the media content are issued to the user account authenticated on first device 120. For example, server 150 may be configured to revoke the full user rights to the media content from the user account authenticated on second device 130 until full user rights to the media content are purchased by the user account authenticated on first device 120. As another example, server 150 may be configured to revoke the full user rights to the media content from the user account authenticated on second device 130 for a predetermined period of time (e.g., for 24 hours). The media content may not be played or reproduced on second device 130, if the full user rights to the media content are deactivated.

In some embodiments, server 150 may not issue the temporary user rights to the media content to the user account authenticated on first device 120, if server 150 does not receive, from the user account authenticated on second device 130, the approval to issue the temporary user rights to the media content.

In some embodiments, server 150 may be configured to determine whether a request to purchase full user rights to the media content is received from first device 120 within a predetermined period of time after server 150 issued, to the user account authenticated on first device 120, the temporary user rights. For example, server 150 may be configured to determine whether the request to purchase full user rights to the media content is received from first device 120 within, e.g., 24 hours after server 150 issued the temporary user rights. First device 120 may be configured to transmit, from the user account authenticated on first device 120 to server 150 in response to receiving the temporary user rights to the media content, the request to purchase full user rights to the media content. First device 120 may be configured to transmit the request to purchase full user rights to the media content, based on the temporary identifier without a formal authenticated identifier for first device 120.

Server 150 may be configured to issue, to the user account authenticated on first device 120, full user rights to the media content, in response to the request to purchase full user rights to the media content. In some embodiments, server 150 may be configured to execute a payment process for the full user rights, and to issue the full user rights upon the execution of the payment. Server 150 may be configured to issue, to the user account authenticated on first device 120, full user rights to the media content, based on the temporary identifier without a formal authenticated identifier for first device 120. Further, server 150 may be configured to store a purchase history of first device 120 in association with the temporary identifier for first device 120. In some embodiments, server 150 may be configured to change the temporary identifier to a formal authenticated identifier for first device 120, after the full user rights to the media content is issued to the user account authenticated on first device 120. Further, server 150 may be configured to store a purchase history of first device 120 in association with the formal authenticated identifier.

Further, server 150 may be configured to restore the temporarily revoked full user rights to the media content to the user account authenticated on second device 130, when server 150 issued the full user rights to the user account authenticated on first device 120. Second device 130 may be configured to then play or reproduce the media content, based on the reactivated full user rights to the media content.

Further, server 150 may be configured to offer or provide a reward to the user account authenticated on second device 130, when the full user rights to the media content is purchased by the user account authenticated on first device 120. Server 150 may be configured to offer or provide a reward to the user account authenticated on second device 130, since second device 130 acted as an intermediary in the transaction of the full user rights to the media content between the user account authenticated on first device 120 and server 150. For example, but not as a limitation, the reward may include at least one of cash, points or a coupon for a purchase of full user rights to other media content.

In some embodiments, server 150 may be configured to determine that no request to purchase full user rights to the media content has been received from first device 120 within a predetermined period of time after server 150 issued, to the user account authenticated on first device 120, the temporary user rights. Server 150 may be configured to then revoke the temporary user rights to the media content from the user account authenticated on first device 120. So the temporary user rights issued to the user account authenticated on first device 120 is deactivated. Further, server 150 may be configured to restore the temporarily revoked full user rights to the media content to the user account authenticated on second device 130. Second device 130 may be configured to then play or reproduce the media content, based on the reactivated full user rights to the media content.

Further, server 150 may be configured to impose a penalty to at least one of the user account authenticated on first device 120 or the user account authenticated on second device 130 if no request to purchase full user rights to the media content has been received from first device 120 within a predetermined period of time after server 150 issued the temporary user rights to the user account authenticated on first device 120. For example, but not as a limitation, server 150 may be configured to temporarily revoke the restored full user rights to the media content from the user account authenticated on second device 130 again for a predetermined period of time. For another example, server 150 may be configured to prohibit the user account authenticated on first device 120 from purchasing other media content for a predetermined period of time.

Thus, FIG. 1 shows example system 10 in which media content management may be implemented, in accordance with various embodiments described herein.

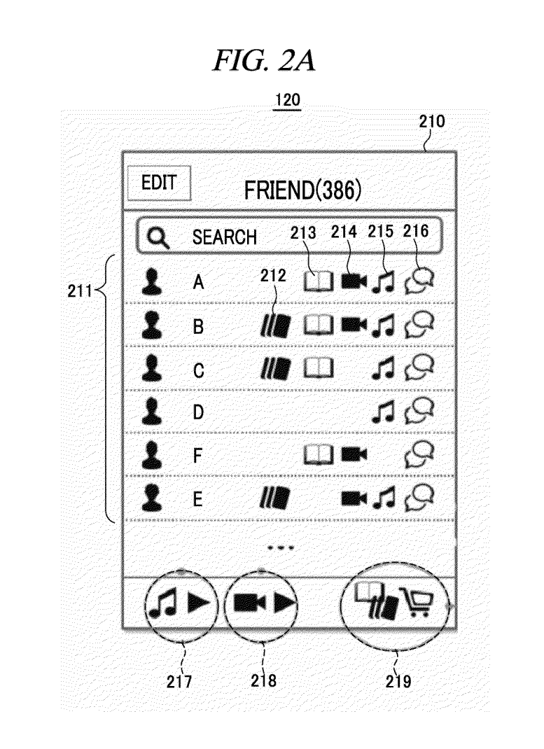

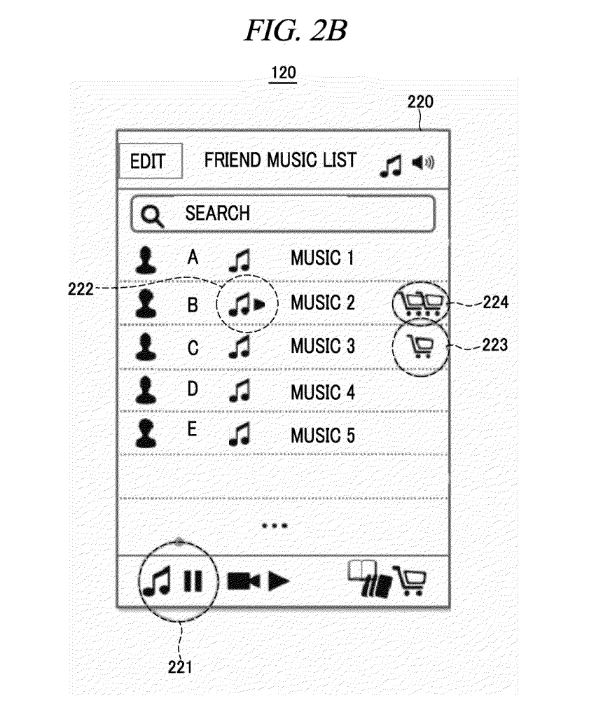

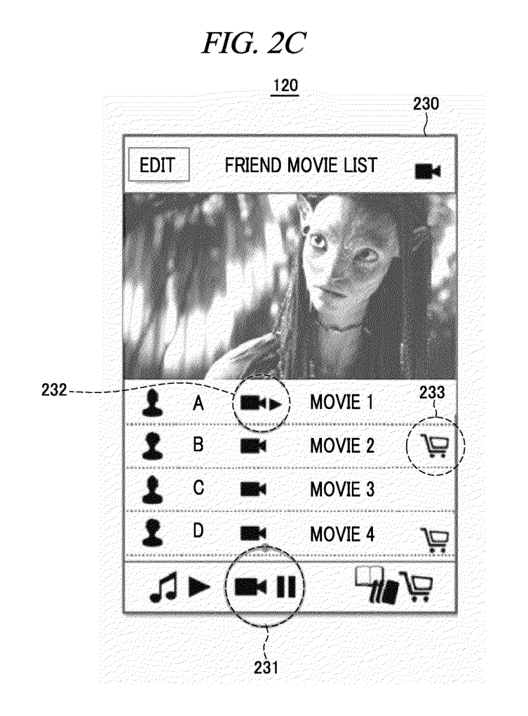

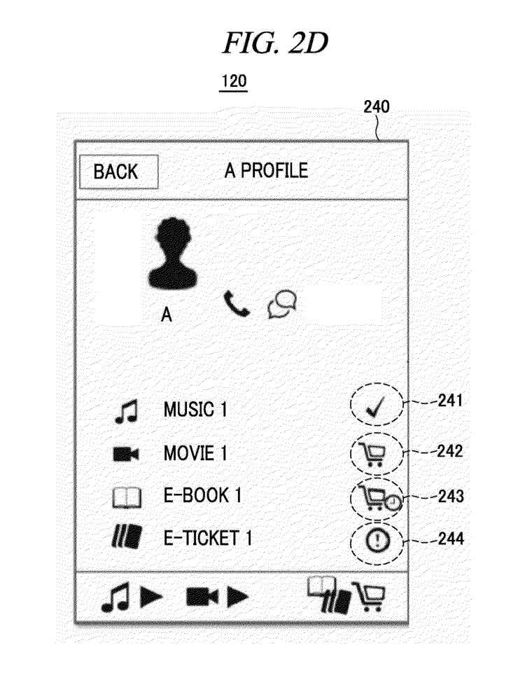

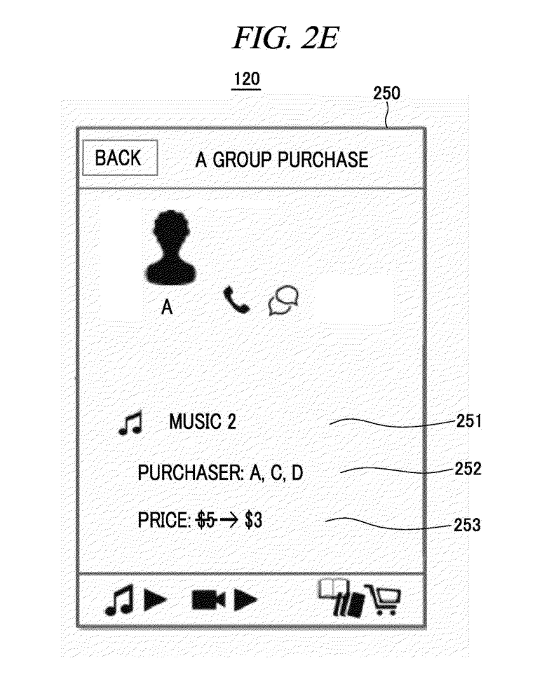

FIGS. 2A to 2E show illustrative example devices by which at least portions of media content management may be implemented, in accordance with various embodiments described herein. For example, first device 120 may be configured to receive, from SNS provider 140, a list 210 that shows identifiers or names 211 of multiple user accounts respectively authenticated on multiple devices, which are associated with a user account authenticated on first device 120 as a friend or acquaintance in a social network service provided by SNS provider 140. Further, as depicted in FIG. 2A, first device 120 may be configured to display list 210 on a display that may be part of, or communicatively coupled to, first device 120.

Further, for example, but not as a limitation, list 210 may further include multiple icons 212, 213, 214, 215, 216, 217, 218 and 219. For example, icon 212 may represent an e-coupon or an e-gift card to which a user account authenticated on a respective device (e.g., friend's device) has full user rights. Icon 213 may represent eBooks to which a user account authenticated on a respective device (e.g., friend's device) has full user rights. Icon 214 may represent video content to which a user account authenticated on a respective device (e.g., friend's device) has full user rights. Icon 215 may represent audio content to which a user account authenticated on a respective device (e.g., friend's device) has full user rights. Icon 216 may be configured to receive a user input to generate a window or a pop-up display on which a conversation between a user account authenticated a device (e.g., friend's device) and the user account authenticated on first device 120 is to be executed.

Further, icon 217 may be configured to receive a user input to play audio content, to which a user account authenticated on a respective device (e.g., friend's device) has full user rights, on first device 120. Further, icon 218 may be configured to receive a user input to play video content, to which a user account authenticated on a respective device (e.g., friend's device) has full user rights, on first device 120. Further, icon 219 may be configured to receive a user input to show list 210 on first device 120.

Further, for example, as depicted in FIG. 2B, first device 120 may be configured to display a friend's music list 220 that shows names of multiple user accounts respectively authenticated on multiple devices (e.g., friends' devices) and names of music content to which each of the user accounts has full user rights. Further, one music (e.g., “music 2”) may be played on first device 120, when first device 120 receives an input to an icon 221 that may be configured to receive a user input to play the music content. Further, first device 120 may be configured to display an icon 222 that may indicate that the music content (e.g., “music 2”) is being played. Further, first device 120 may be configured to display an icon 223 that may be configured to receive a user input to purchase full user rights to music content (e.g., “music 3”). Further, first device 120 may be configured to display an icon 224 that may be configured to receive a user input to purchase full user rights to music content (e.g., “music 2”) as a group purchase.

Further, for example, as depicted in FIG. 2C, first device 120 may be configured to display a friends' movie list 230 that shows names of multiple user accounts respectively authenticated on multiple devices (e.g., friends' devices) and names of movies to which each of the user accounts has full user rights. Further, one movie (e.g., “movie 1”) may be reproduced on first device 120, when first device 120 receives an input to an icon 231 that may be configured to receive a user input to play the movie. Further, first device 120 may be configured to display an icon 232 that may indicate that the movie (e.g., “movie 1”) is being played. Further, first device 120 may be configured to display an icon 233 that may be configured to receive a user input to purchase full user rights to movie (e.g., “movie 2”).

Further, for example, as depicted in FIG. 2D, first device 120 may be configured to display a friends' profile list 240 that includes names of media content (e.g., music, movie, e-book, or e-ticket) to which a user account authenticated on a device (e.g., friend's device A) has full user rights, when first device 120 receives a user input to select the device (e.g., friend's device A) in list 210 of FIG. 2A. Further, first device 120 may be configured to display an icon 241 that may represent that a user account authenticated on first device 120 has already purchased the media content (e.g., “music 1”). Further, first device 120 may be configured to display an icon 242 that may be configured to receive a user input to purchase full user rights to the media content (e.g., “movie 1”). Further, first device 120 may be configured to display an icon 243 that may indicate that the media content (e.g., “e-book 1”) is resalable content that has valid user rights. Further, first device 120 may be configured to display an icon 244 that may be configured to receive a user input to show additional information regarding the media content (e.g., “e-ticket 1”). For example, the additional information regarding the media content may include a price of the media content, an authorized number of uses or plays of the media content or a review or reputation of other users for the media content.

Further, for example, as depicted in FIG. 2E, first device 120 may be configured to display a group purchase interface 250, when first device 120 receives, in friends' music list 220 of FIG. 2B, a user input to select icon 224 that may be configured to receive a user input to purchase full user rights to media content (e.g., “music 2”) by a group purchase. Group purchase interface 250 may include a name 251 of target media content (e.g., “music 2”), names 252 of purchasers (e.g., names of user accounts) participating in the group purchase of the target media content and reduced price 253 of the target media content in the group purchase.

Thus, FIGS. 2A to 2E show illustrative example devices by which at least portions of media content management may be implemented, in accordance with various embodiments described herein.

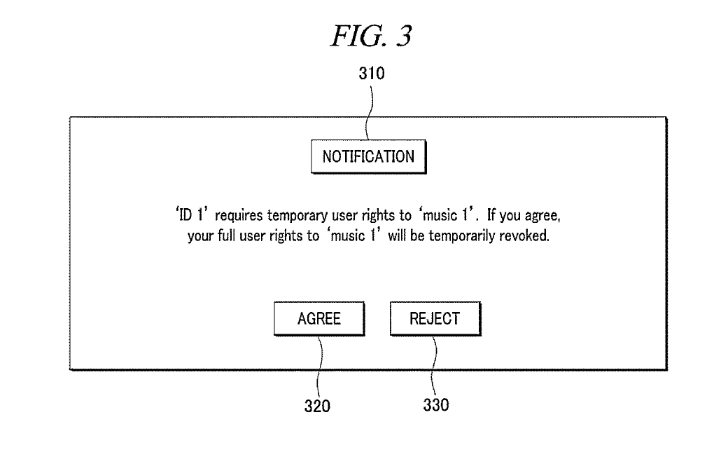

FIG. 3 shows an illustrative example of a notification transmitted by a server by which at least portions of media content management may be implemented, in accordance with various embodiments described herein. For example, server 150 may be configured to transmit a notification 310 to second device 130, when server 150 receives, from first device 120, a request for temporary user rights to media content to which a user account authenticated on second device 130 has full user rights. For example, as depicted in FIG. 3, notification 310 may indicate that a user account (e.g., “ID 1”) authenticated on first device 120 requires temporary user rights to media content (e.g., “music 1”) to which the user account authenticated on second device 130 has full user rights. Further, notification 310 may indicate that the full user rights to the media content (e.g., “music 1”) may be temporarily revoked, if server 150 issues the temporary user rights to the media content (e.g., “music 1”) to the user account authenticated on first device 120.

Further, second device 130 may be configured to transmit, from the user account authenticated on second device 130 to server 150, approval to issue the temporary user rights to the media content to the user account authenticated on first device 120 when second device 130 receives an input to an agree icon 320 displayed in notification 310. Further, server 150 may be configured to issue, to the user account authenticated on first device 120, the temporary user rights to the media content, when server 150 receives the approval from second device 130.

Further, second device 130 does not transmit, to server 150, approval to issue the temporary user rights when second device 130 receives an input to a reject icon 330 displayed in notification 310. Further, server 150 does not issue the temporary user rights to the media content to the user account authenticated on first device 120 if server 150 does not receive, from second device 130, the approval to issue the temporary user rights to the media content.

Thus, FIG. 3 shows an illustrative example of a notification transmitted by a server by which at least portions of media content management may be implemented, in accordance with various embodiments described herein.

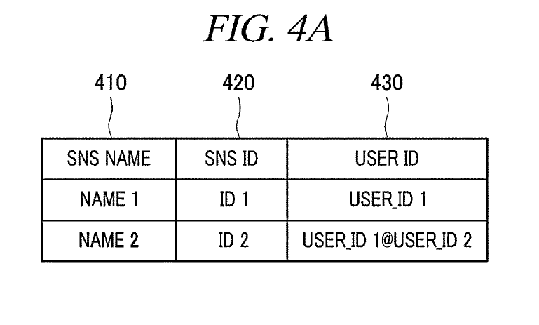

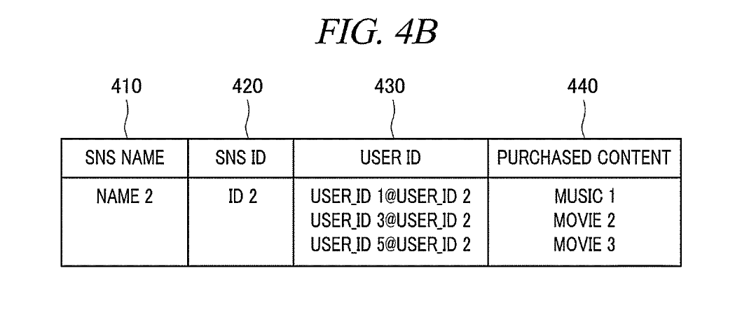

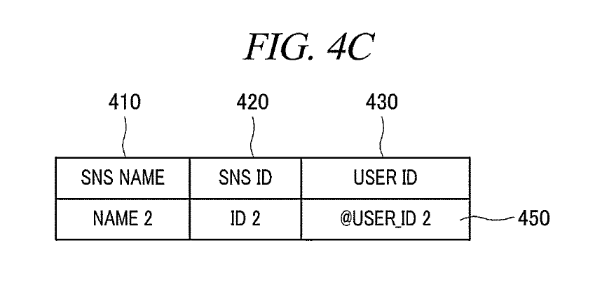

FIGS. 4A to 4C show illustrative examples of an identifier storage of a server by which at least portions of media content management may be implemented, in accordance with various embodiments described herein. For example, it may be assumed that server 150 issued a formal authenticated identifier to a user account authenticated on second device 130, but server 150 has not yet issued a formal authenticated identifier to a user account authenticated on first device 120.

First device 120 may be configured to transmit, from the user account authenticated on first device 120 to server 150, a request for temporary user rights to media content, to which the user account authenticated on second device 130 has full user rights, without an identifier for first device 120, since server 150 has not yet issued an authenticated identifier to the user account authenticated on first device 120. Further, first device 120 may be configured to transmit, to server 150, the request for the temporary user rights to the media content, along with an identifier for second device 130. Server 150 may be configured to then issue, to the user account authenticated on first device 120, a temporary identifier, based on the identifier for second device 130, upon receiving the request accompanied by the identifier for second device 130. For example, as depicted in FIG. 4A, server 150 may issue a formal authenticated identifier for second device 130 (e.g., “user_ID 1”), and server 150 may issue a temporary identifier for first device 120 (e.g., “user_ID 1@user_ID 2”). For example, but not as a limitation, as depicted in FIG. 4A, the temporary identifier for first device 120 may include at least a part of the formal authenticated identifier for second device 130.

Further, as depicted in FIG. 4A, server 150 may be configured to store SNS names 410 and SNS ID 420 in association with user ID 430. For example, server 150 may be configured to store an “SNS name 1” and an “SNS ID 1” for second device 130 in association with the formal authenticated identifier (e.g., “user_ID 1”) for second device 130. Further, server 150 may be configured to store an “SNS name 2” and an “SNS ID 2” for first device 120 in association with the temporary identifier (e.g., “user_ID 1@user_ID 2”) for first device 120.

Further, as depicted in FIG. 4B, server 150 may be configured to store a purchase history of a device (e.g., first device 120) in association with the temporary identifier for the device (e.g., first device 120). Server 150 may be configured to store SNS name 410 and SNS ID 420 in association with user ID 430 and purchased content 440. For example, it may be assumed that a user account authenticated on first device 120 has purchased media content (e.g., “music 1”) to which a user account authenticated on second device 130 has full user rights. A formal authenticated identifier for second device 130 is “user_ID 1”. Further, the user account authenticated on first device 120 has purchased media content (e.g., “movie 2”) to which a user account authenticated on another device has full user rights. A formal authenticated identifier for the other device is “user_ID 3”. Further, the user account authenticated on first device 120 has purchased media content (e.g., “movie 3”) to which a user account authenticated on another device has full user rights. A formal authenticated identifier for the other device is “user_ID 5”.

Server 150 may be configured to store purchased content 440 in association with user ID 430. For example, as depicted in FIG. 4B, server 150 may be configured to store a name of the media content (e.g., “music 1”) in association with a temporary identifier for first device 120 (e.g., “user_ID 1@user_ID 2”). Further, server 150 may be configured to store a name of the media content (e.g., “movie 2”) in association with a temporary identifier for first device 120 (e.g., “user_ID 3@user_ID 2”). Further, server 150 may be configured to store a name of the media content (e.g., “movie 3”) in association with a temporary identifier for first device 120 (e.g., “user_ID 5@user_ID 2”).

Further, server 150 may be configured to change a temporary identifier for a device (e.g., first device 120) to a formal authenticated identifier for the device, if full user rights to media content is purchased by a user account authenticated on the device within a predetermine time after temporary user rights to the media content were issued to the user account authenticated on the device.

For example, if a user account authenticated on first device 120 purchases full user rights to media content within a day after server 150 issued temporary user rights to the media content to the user account authenticated on first device 120, server 150 may be configured to change a temporary identifier for first device 120 (e.g., “user_ID 1@user_ID 2”) to a formal authenticated identifier for first device 120 (e.g., “@user_ID 2”).

Thus, FIGS. 4A to 4C show illustrative examples of an identifier storage of a server by which at least portions of media content management may be implemented, in accordance with various embodiments described herein.

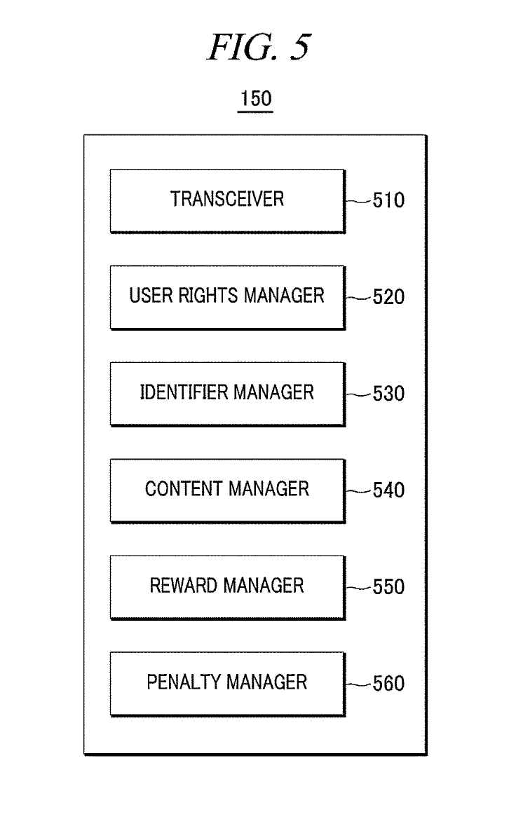

FIG. 5 shows an example server 150 by which at least portions of media content management may be implemented, in accordance with various embodiments described herein. As depicted in FIG. 5, server 150 may include a transceiver 510, a user rights manager 520, an identifier manager 530, a content manager 540, a reward manager 550 and a penalty manager 560. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of transceiver 510, user rights manager 520, identifier manager 530, content manager 540, reward manager 550 and penalty manager 560 may be included in an instance of an application hosted on server 150.

Transceiver 510 may be configured to receive, from first device 120, a request for temporary user rights to media content to which a user account authenticated on second device 130 has full user rights. In some embodiments, first device 120 may be configured to receive, from SNS provider 140, a media content list that shows multiple media content to which the user account authenticated on second device 130 has full user rights. Further, first device 120 may be configured to receive a user input to select at least one media content from the media content list. Further, first device 120 may be configured to transmit, from a user account authenticated on first device 120 to transceiver 510, a request for temporary user rights to the selected media content, based on the received user input.

Further, transceiver 510 may be configured to receive the request for the temporary user rights to the media content without an identifier for first device 120. Transceiver 510 may be configured to receive the request for the temporary user rights along with an identifier for second device 130 that has full user rights to the media content.

Further, transceiver 510 may be configured to transmit, to second device 130, a notification that server 150 will issue, to the user account authenticated on first device 120, the temporary user rights to the media content. Further, transceiver 510 may be configured to receive, from second device 130, approval to issue the temporary user rights to the media content to the user account authenticated on first device 120.

Further, transceiver 510 may be configured to receive, from first device 120, a request for the media content, based on the temporary user rights to the media content. Further, transceiver 510 may be configured to receive, from first device 120, a request to purchase full user rights to the media content, based on the temporary user rights to the media content.

User rights manager 520 may be configured to issue, to the user account authenticated on first device 120, the temporary user rights to the media content, when transceiver 510 receives, from second device 130, the approval to issue the temporary user rights to the media content.

Further, user rights manager 520 may be configured to temporarily revoke the full user rights to the media content from the user account authenticated on second device 130, if the temporary user rights to the media content are issued to the user account authenticated on first device 120. For example, user rights manager 520 may be configured to revoke the full user rights to the media content from the user account authenticated on second device 130, until full user rights to the media content are purchased by the user account authenticated on first device 120. For another example, user rights manager 520 may be configured to revoke the full user rights to the media content from the user account authenticated on second device 130 for a predetermined period of time (e.g., for 24 hours). The media content may not be played or reproduced on second device 130, if the full user rights to the media content are revoked.

Further, user rights manager 520 may be configured to issue, to the user account authenticated on first device 120, the full user rights to the media content. In some embodiments, user rights manager 520 may be configured to issue, to the user account authenticated on first device 120, the full user rights to the media content, based on a temporary identifier for first device 120 without a formal authenticated identifier. Further, user rights manager 520 may be configured to restore the temporarily revoked full user rights to the media content to the user account authenticated on second device 130, when user rights manager 520 issued the full user rights to the user account authenticated on first device 120. Second device 130 may be configured to then play or reproduce the media content, based on the restored full user rights to the media content.

Further, user rights manager 520 may be configured to revoke the temporary user rights to the media content from the user account authenticated on first device 120 if no request to purchase full user rights to the media content has been received from first device 120 within a predetermined period of time after user rights manager 520 issued, to the user account authenticated on first device 120, the temporary user rights. Further, user rights manager 520 may be configured to restore the temporarily revoked full user rights to the media content to the user account authenticated on second device 130.

Identifier manager 530 may be configured to issue, to the user account authenticated on first device 120, a temporary identifier, based on the identifier for second device 130, which accompanies with the request for the temporary user rights to the media content.

Further, identifier manager 530 may be configured to change the temporary identifier for first device 120 to a formal authenticated identifier, when the full user rights to the media content is issued to the user account authenticated on first device 120.

Content manager 540 may be configured to transmit, to first device 120, the media content, when transceiver 510 receives, from first device 120, the request for the media content based on the temporary user rights to the media content. For example, content manager 540 may be configured to transmit, to first device, an electronic file to play the media content. For another example, content manager 540 may be configured to stream the media content to first device 120.

Reward manager 550 may be configured to offer or provide a reward to the user account authenticated on second device 130, when the full user rights to the media content is purchased by the user account authenticated on first device 120 after the temporary user rights to the media content was issued. For example, but not as a limitation, the reward may include at least one of cash, points or a coupon for a purchase of full user rights to other media content.

Penalty manager 560 may be configured to impose a penalty to at least one of the user account authenticated on first device 120 or the user account authenticated on second device 130 if no request to purchase full user rights to the media content has been received from first device 120 within a predetermined period of time after user rights manager 520 issued, to the user account authenticated on first device 120, the temporary user rights.

Thus, FIG. 5 shows an example server 150 by which at least portions of media content management may be implemented, in accordance with various embodiments described herein.

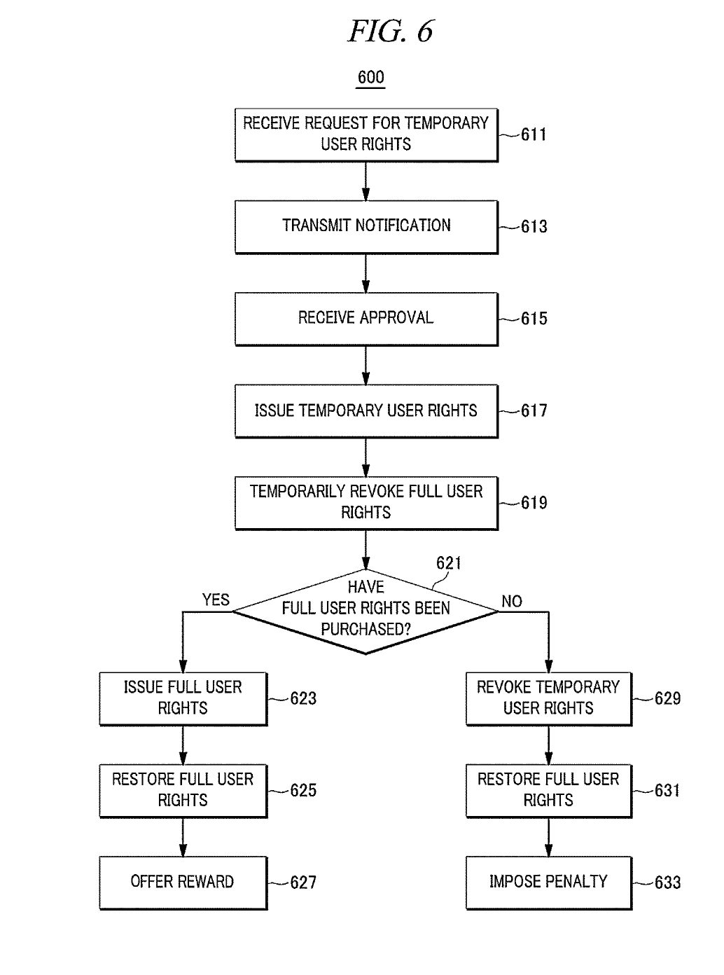

FIG. 6 shows an example processing flow 600 of operations by which at least portions of media content management may be implemented, in accordance with various embodiments described herein. The operations of processing flow 600 may be implemented in system configuration 10 including first device 120, second device 130, SNS provider 140 and server 150, as illustrated in FIG. 1. Processing flow 600 may include one or more operations, actions, or functions as illustrated by one or more blocks 611, 613, 615, 617, 619, 621, 623, 625, 627, 629, 631 and/or 633. Although illustrated as discrete blocks, various blocks may be divided into additional blocks, combined into fewer blocks, or eliminated, depending on the desired implementation. Processing may begin at block 611.

Block 611 (Receive Request for Temporary User Rights) may refer to server 150 receiving, from first device 120, a request for temporary user rights to media content to which a user account authenticated on second device 130 has full user rights. For example, the user account authenticated on second device 130 may be associated with a user account authenticated on first device 120 as a friend or an acquaintance in social networking services provided by SNS provider 140. In some embodiments, server 150 may receive, from first device 120, an input to select the media content from a media content list that is displayed on first device 120 and shows multiple media content to which the user account authenticated on second device 130 has full user rights. At block 611, server 150 may receive the request for the temporary user rights to the media content without an identifier for first device 120. Server 150 may receive the request for the temporary user rights along with an identifier for second device 130. Further, at block 611, server 150 may issue, to the user account authenticated on first device 120, a temporary identifier, based on the received identifier for second device 130. Processing may proceed from block 611 to block 613.

Block 613 (Transmit Notification) may refer to server 150 transmitting, to second device 130, a notification that server 150 will issue, to the user account authenticated on first device 120, the temporary user rights to the media content. Processing may proceed from block 613 to block 615.

Block 615 (Receive Approval) may refer to server 150 receiving, from second device 130, approval to issue, to the user account authenticated on first device 120, the temporary user rights to the media content. Processing may proceed from block 615 to block 617.

Block 617 (Issue Temporary User Rights) may refer to server 150 issuing, to the user account authenticated on first device 120, the temporary user rights to the media content. Processing may proceed from block 617 to block 619.

Block 619 (Temporarily Revoke Full User Rights) may refer to server 150 temporarily revoking the full user rights to the media content from the user account authenticated on second device 130. For example, at block 619, server 150 may revoke the full user rights to the media content from the user account authenticated on second device 130, until full user rights to the media content are purchased by the user account authenticated on first device 120. Processing may proceed from block 619 to block 621.

Block 621 (Determine Whether Full User Rights Have Been Purchased) may refer to server 150 determining whether the full user rights to the media content have been purchased by the user account authenticated on first device 120. In some embodiments, at block 621, server 150 may determine whether a request to purchase full user rights to the media content is received from first device 120 within a predetermined period of time after server 150 issued, to the user account authenticated on first device 120, the temporary user rights. If server 150 determines that a request to purchase full user rights to the media content is received from first device 120, processing may proceed to block 623, while otherwise, processing may proceed to block 629.

Block 623 (Issue Full User Rights) may refer to server 150 issuing, to the user account authenticated on first device 120, the full user rights to the media content. In some embodiments, server 150 may issue the full user rights to the media content, based on the temporary identifier for first device 120 without a formal authenticated identifier. Further, server 150 may store a purchase history in association with the temporary identifier for first device 120. Processing may proceed from block 623 to block 625.

Block 625 (Restore Full User Rights) may refer to server 150 restoring the full user rights to the media content, which is temporarily revoked at block 619, to the user account authenticated on second device 130. Processing may proceed from block 625 to block 627.

Block 627 (Offer Reward) may refer to server 150 offering or providing a reward to the user account authenticated on second device 130. For example, but not as a limitation, the reward may include at least one of cash, points or a coupon for a purchase of full user rights to other media content.

Block 629 (Revoke Temporary User Rights) may refer to server 150 revoking the temporary user rights to the media content, which is issued at block 617, from the user account authenticated on first device 120. Processing may proceed from block 629 to block 631.

Block 631 (Restore Full User Rights) may refer to server 150 restoring the full user rights to the media content, which is temporarily revoked at block 619, to the user account authenticated on second device 130. Processing may proceed from block 631 to block 633.

Block 633 (Impose Penalty) may refer to imposing a penalty to at least one of the user account authenticated on first device 120 or the user account authenticated on second device 130. For example, but not as a limitation, server 150 may temporarily revoke the restored full user rights to the media content from the user account authenticated on second device 130 again for a predetermined period of time. For another example, server 150 may prohibit the user account authenticated on first device 120 from purchasing other media content for a predetermined period of time.

Thus, FIG. 6 shows an example processing flow 600 of operations by which at least portions of media content management may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

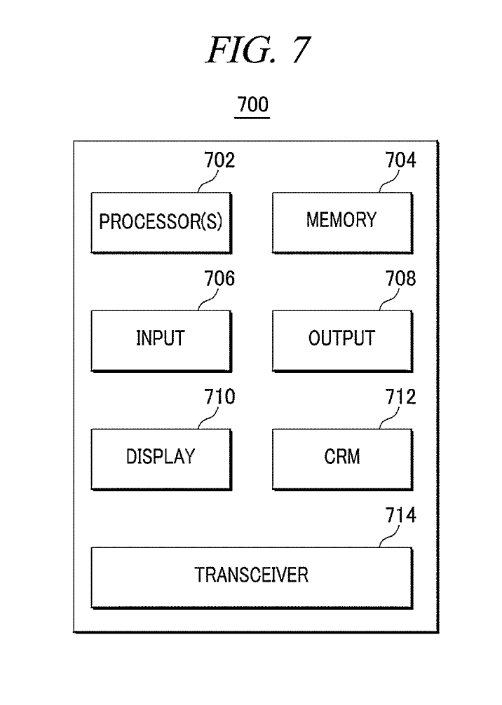

FIG. 7 shows an illustrative computing embodiment, in which any of the processes and sub-processes of media content management may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 700 may typically include, at least, one or more processors 702, a system memory 704, one or more input components 706, one or more output components 708, a display component 710, a computer-readable medium 712, and a transceiver 714.

Processor 702 may refer to, e.g., a microprocessor, a microcontroller, a digital signal processor, or any combination thereof.

Memory 704 may refer to, e.g., a volatile memory, non-volatile memory, or any combination thereof. Memory 704 may store, therein, an operating system, an application, and/or program data. That is, memory 704 may store executable instructions to implement any of the functions or operations described above and, therefore, memory 704 may be regarded as a computer-readable medium.

Input component 706 may refer to a built-in or communicatively coupled keyboard, touch screen, or telecommunication device. Alternatively, input component 706 may include a microphone that is configured, in cooperation with a voice-recognition program that may be stored in memory 704, to receive voice commands from a user of computing device 700. Further, input component 706, if not built-in to computing device 700, may be communicatively coupled thereto via short-range communication protocols including, but not limitation, radio frequency or Bluetooth.

Output component 708 may refer to a component or module, built-in or removable from computing device 700, that is configured to output commands and data to an external device.

Display component 710 may refer to, e.g., a solid state display that may have touch input capabilities. That is, display component 710 may include capabilities that may be shared with or replace those of input component 706.

Computer-readable medium 712 may refer to a separable machine readable medium that is configured to store one or more programs that embody any of the functions or operations described above. That is, computer-readable medium 712, which may be received into or otherwise connected to a drive component of computing device 700, may store executable instructions to implement any of the functions or operations described above. These instructions may be complimentary or otherwise independent of those stored by memory 704.

Transceiver 714 may refer to a network communication link for computing device 700, configured as a wired network or direct-wired connection. Alternatively, transceiver 714 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system, comprising:
a first device configured to transmit a request for temporary user rights to media content; and
a server configured to:
receive the request from the first device,
transmit, to a second device having full user rights to the media content, a notification that the server will issue the temporary user rights to the media content to a user account authenticated on the first device,
receive, from the second device, an approval to issue the temporary user rights to the media content to the user account authenticated on the first device,
issue the temporary user rights to the user account authenticated on the first device, and
temporarily revoke the full user rights to the media content from a user account authenticated on the second device.

2. The system of claim 1,
wherein the first device is further configured to:
transmit, to the server, responsive to receiving the temporary user rights to the media content, a request to purchase full user rights to the media content, and
wherein the server is further configured to:
issue the requested full user rights to the media content to the user account authenticated on the first device, and
restore the temporarily revoked full user rights to the media content to the user account authenticated on the second device.

3. The system of claim 2,
wherein the server is further configured to offer a reward to the user account authenticated on the second device,
wherein further the reward includes at least one of cash, points or a coupon for a purchase of full user rights to other media content.

4. The system of claim 1, wherein the server is further configured to:
determine that no request to purchase full user rights to the media content has been received from the first device within a predetermined time after the server issued the temporary user rights to the user account authenticated on the first device,
revoke the temporary user rights to the media content from the user account authenticated on the first device, and
restore the temporarily revoked full user rights to the media content to the user account authenticated on the second device.

5. The system of claim 4, wherein the server is further configured to impose a penalty to at least one of the user account authenticated on the first device or the user account authenticated on the second device.

6. The system of claim 1,
wherein the first device is configured to transmit the request for temporary user rights to the media content without an identifier for the first device, and
wherein the server is further configured to store an identifier for the second device.

7. The system of claim 1,
wherein the first device is configured to transmit the request for temporary user rights to the media content, along with an identifier for the second device, to the server, and
wherein the server is further configured to issue, to the user account authenticated on the first device, a temporary identifier, based on the identifier for the second device.

8. The system of claim 7,
wherein the server is further configured to issue, to the user account authenticated on the first device, full user rights to the media content based on the temporary identifier, and
wherein the server is further configured to store a purchase history of the first device in association with the temporary identifier.

9. The system of claim 1,
wherein the server is further configured to:
receive, from the first device, a request for the media content, based on the temporary user rights to the media content, and
transmit the requested media content to the first device,
wherein the first device is further configured to play the transmitted media content.

10. The system of claim 1, wherein the user account authenticated on the first device is associated with the user account authenticated on the second device via a social network service.

11. The system of claim 10,
wherein the first device is further configured to:
receive, from the social network service, a content list that shows multiple media contents to which the user account authenticated on the second device has full user rights;
display the content list; and
receive a user input to select the media content from among the multiple media contents,
wherein the first device is configured to transmit the request for temporary user rights to the media content based on the received user input.

12. A server, comprising:
a transceiver configured to:
receive, from a first device, a request for temporary user rights to media content,
transmit, to a second device having full user rights to the media content, a notification that the server will issue the temporary user rights to the media content to a user account authenticated on the first device, and
receive, from the second device, an approval to issue the temporary user rights to the media content to the user account authenticated on the first device; and
a user rights manager configured to:
issue the temporary user rights to the user account authenticated on the first device, and
temporarily revoke the full user rights to the media content from a user account authenticated on the second device.

13. The server of claim 12,
wherein the transceiver is further configured to receive, from the first device, a request to purchase full user rights to the media content, based on the temporary user rights, and
wherein the user rights manager is further configured to:
issue the requested full user rights to the media content to the user account authenticated on the first device, and
restore the temporarily revoked full user rights to the media content to the user account authenticated on the second device.

14. The server of claim 13, further comprising:
a reward manager configured to offer a reward to the user account authenticated on the second device, and
wherein the reward includes at least one of cash, points or a coupon for a purchase of full user rights to other media content.

15. The server of claim 12, wherein the user rights manager is further configured to:
revoke the temporary user rights to the media content from the user account authenticated on the first device, if no request to purchase full user rights to the media content has been received from the first device within a predetermined time after the user rights manager issued the temporary user rights to the user account authenticated on the first device, and
restore the temporarily revoked full user rights to the media content to the user account authenticated on the second device.

16. The server of claim 15, further comprising:
a penalty manager configured to impose a penalty to at least one of the user account authenticated on the first device or the user account authenticated on the second device.

17. The server of claim 12,
wherein the transceiver is further configured to:
receive, from the first device, a request for the media content, based on the temporary user rights to the media content, and
wherein the server further comprises:
a content manager configured to transmit the requested media content to the first device.

18. The server of claim 12,
wherein the transceiver is further configured to receive, from the first device, an identifier for the second device, along with the request for temporary user rights to the media content, and
wherein the server further comprises:
an identifier manager configured to issue, to the user account authenticated on the first device, a temporary identifier, based on the identifier for the second device.

19. A method performed under control of a server, comprising:
receiving, from a first device, a request for temporary user rights to media content;
transmitting, to a second device having full user rights to the media content, a notification that the server will issue the temporary user rights to the media content to a user account authenticated on the first device;
receiving, from the second device, an approval to issue the temporary user rights to the media content to the user account authenticated on the first device;
issuing the temporary user rights to the user account authenticated on the first device; and
temporarily revoking the full user rights to the media content from a user account authenticated on the second device.

20. The method of claim 19,
wherein the request for temporary user rights to the media content is accompanied by an identifier for the second device,
wherein the method further comprises:
issuing, to the user account authenticated on the first device, a temporary identifier, based on the identifier for the second device.
